(19) United States
(12) Patent Application Publication
(10) Pub. No.: US 2002/0186529 A1
(43) Pub. Date: Dec. 12, 2002

(54) Notebook computer whose base unit's top face allows direct visibility of the rotating device

(76) Inventor: Yu-Fu Huang, Taoyuan (TW)

Correspondence Address: RABIN & BERDO, P.C., 1101 14th Street, N.W., Washington, DC, 20005, US

(21) Appl. No.: 10/084,345

(22) Filed: Feb. 28, 2002

(30) Foreign Application Priority Data
Jun. 6, 2001 (TW) 90209418

(51) Int. Cl. G06F 1/16

(52) U.S. Cl. 361/683

(57) ABSTRACT

A notebook computer whose base unit's top face allows direct visibility of the rotating device including a base unit, which comprises a base unit's top face and a rotating device, is provided. Of which, the base unit's top face has a transparent window and the rotating device is situated inside the base unit and beneath the transparent window. A notebook's base unit according to the invention is designed to have a transparent window through which the user can directly check the rotating device and assures whether the rotating device is under normal operation or not.

This application incorporates by reference Taiwanese application Serial No. 90209418, Filed Jun. 6, 2001.

### BACKGROUND OF THE INVENTION

1. Field of the Invention

The invention relates in general to notebook computer, and more particularly to a notebook computer whose base unit's top face allows direct visibility of the rotating device.

2. Description of the Related Art

Along with the advance in technology and rapid growth of information, the use of computer has become more and more popular. Nowadays, the computer has become an indispensable appliance for modern people in their everyday lives, especially the notebook computer, which has won great popularity with modem people who strive for efficiency because of its features of compactness and portability.

Please refer to FIG. 1A, a three-dimensional schematic diagram of a conventional notebook computer is illustrated. The notebook computer 100 according to FIG. 1 includes a base unit 102 and a covering board 104, wherein the covering board 104 is connected to the base unit using a pivotal spindle 106 such that the covering board 104 can close to and open from the base unit 102. Furthermore, the covering board 104 comprises a display panel 108, a Liquid Crystal Display (LCD) for instance, used to display signals. The base unit 102 further comprises a rotating device, a base unit's top face 110, a keyboard session 112 and a Central Process Unit (CPU) 116. Of which, the rotating device can be a CD-ROM 114 or a fan 118 for instance; the keyboard session 112 is situated at an opening 120 of the base unit's top face 110 with which the user inputs operation signals; and the CD-ROM 114, being situated at a slot 122 of the base unit 102, is detachable from the base unit 102 and is used to accommodate and read the compact disc. Apart from that, both the CPU 116 and the fan 118 are installed inside the base unit 102, wherein the fan 118 is situated above the CPU 116 so that the heat generated during the operation of the CPU 116 can be ventilated and a normal operation of the CPU 116 can be maintained. By doing so, the damage of the CPU 116 because of high temperature and a decrease in the efficiency of operation can be prevented.

It is noteworthy that a conventional base unit 110 is made of non-transparent materials. As shown in FIG. 1B, a bird's-eye view of the base unit in FIG. 1A is illustrated. The user cannot directly see the inner structure of the base unit 102 through the base unit's top face 110 to assure if the CD-ROM 114 or the fan 118 is under normal operation. Normally, the user has to disassemble the base unit 102 using a screw driver and open the base unit's top face 110 before he or she can examine the inner structure of the base unit 102 and check whether the CD-ROM 114 or the fan 118 is under normal operation or not. After the user has examined everything and a normal operation is assured, he or she has to assemble the parts, which is indeed a waste of time and very inconvenient.

### SUMMARY OF THE INVENTION

It is therefore an object of the invention to provide a notebook computer whose base unit's top face allows direct visibility of the rotating device. The design of a transparent window at the base unit's top face situated above the rotating device allows direct visibility of the rotating device through the base unit's top face. The user can see the rotating device through the transparent window to assure whether the rotating device is under normal operation or not.

According to the object of the invention, a notebook computer whose base unit's top face allows direct visibility of the rotating device including a base unit which comprises a base unit's top face and a rotating device is provided. Of which, the base unit's top face has a transparent window and the rotating device is situated inside the base unit and beneath the transparent window.

### BRIEF DESCRIPTION OF THE DRAWINGS

Other objects, features, and advantages of the invention will become apparent from the following detailed description of the preferred but non-limiting embodiments. The description is made with reference to the accompanying drawings in which:

FIG. 1A shows a three dimensional schematic diagram of a conventional notebook computer;

FIG. 1B shows a bird's-eye view of the base unit in FIG. 1A; and

FIG. 2 shows a bird's-eye view of a notebook computer whose base unit's top face allows direct visibility of the rotating device.

### DESCRIPTION OF THE PREFERRED EMBODIMENT

The design of a transparent window at the base unit's top face situated above the rotating device according to the invention allows direct visibility of the rotating device through the base unit's top face. The user can directly see the rotating device through the transparent window to assure whether the rotating device is under normal operation or not. The invention will be explained using the structure of the base unit, while the structure of the covering board will not be repeated here. As for the practical application of the invention is disclosed in the following preferred embodiments of the invention.

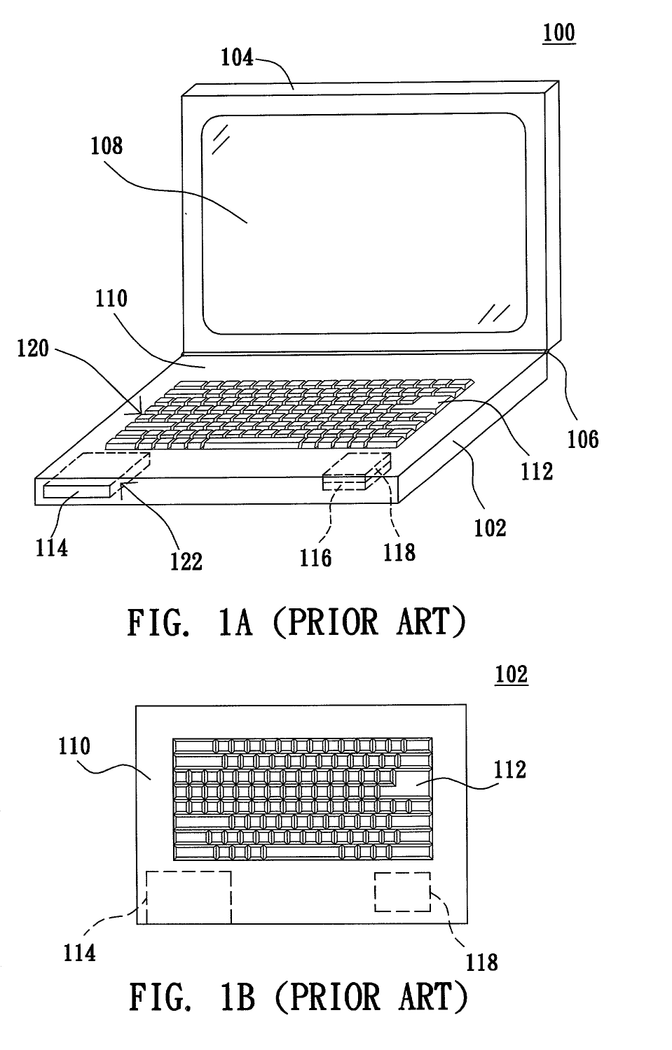

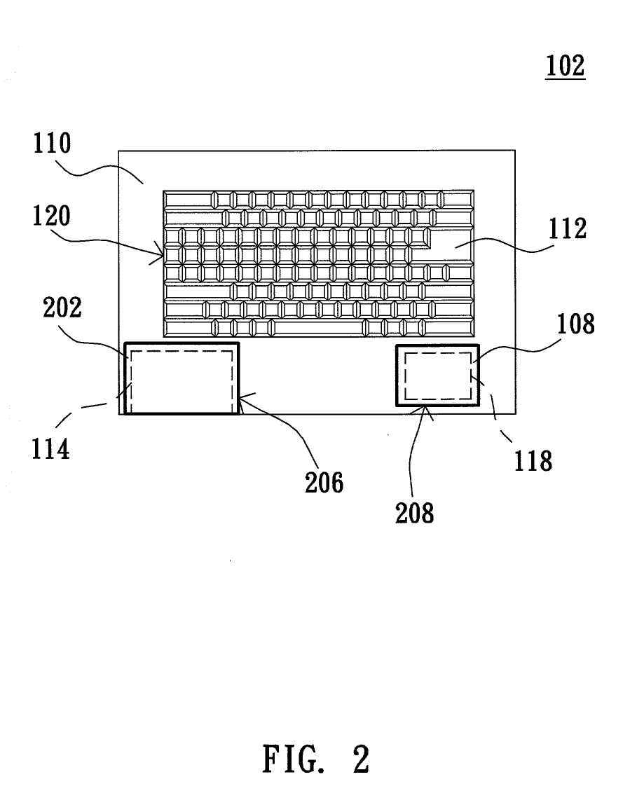

Referring to FIG. 2, a bird's-eye view of a notebook computer whose base unit's top face allows direct visibility of the rotating device according to a preferred embodiment of the invention is illustrated. FIG. 2 differs from FIG. 1A in that the transparent windows 202 and 204 according to the embodiment of the invention are respectively installed at the openings 206 and 208 of the base unit's top face 110, while the transparent windows 202 and 204 are respectively located at the top of the CD-ROM 114 and the fan 118. So the user can see the CD-ROM 114 and the fan 118 through the transparent windows 202 and 204 to assure that the CD-ROM 114 and the fan 118 are under normal operation from outside the base unit 102. By means of this arrangement, the user does not need to disassemble the base unit 102 using screw drivers and open the base unit's top face 110 if he or she would like to check the inner structure of the base unit 102 and make sure if the CD-ROM 114 or the fan 118 is under normal operation. After the user has finished examination and assures that everything runs smoothly, he or she does not need to assemble the parts of the base unit 110 again. It is indeed very convenient and timesaving to the user.

A notebook's base unit allows direct visibility of the rotating device through the base unit's top face according to the invention is disclosed in the above embodiment. The user can directly see the rotating device through the transparent window which is situated at the base unit's top face to assure whether the rotating device is under normal operation or not.

While the invention has been described by way of example and in terms of the preferred embodiment, it is to be understood that the invention is not limited to the disclosed embodiment. Any one who is familiar with the technology of the invention can do a variety of adjustments, variations and modifications without parting from the spirit and the scope of the invention. For example, the rotating device is not necessarily limited to the CD-ROM or the fan. Both the floppy disk and hard disk drive, which have been equipped with a rotating disk, are to be included. The rotating disk session of a floppy disk or a hard disk drive can be designed to be a transparent session. Therefore, as long as there are parts operating inside the inner structure of the base unit, additional transparent windows can be designed providing direct visibility of the operating parts. So the user can check directly if the parts are under normal operation from outside the base unit. Therefore, the scope of protection of the invention is defined in the appended claims; and it is to be understood that invention is intended to cover various modifications and similar arrangements and procedures, and the scope of the appended claims therefore should be accorded the broadest interpretation so as to encompass all such modifications and similar arrangements and procedures.

What is claimed is:

1. A notebook computer whose base unit's top face allows direct visibility of the rotating device, wherein the notebook computer comprises a base unit comprising:
a base unit's top face with a transparent window; and
a rotating device situated inside the base unit and beneath the transparent window through which the status of the rotating device can be observed.

2. A notebook computer's base unit according to claim 1, wherein the rotating device is a CD-ROM.

3. A notebook computer's base unit according to claim 1, wherein the rotating device is a fan.

4. A notebook computer's base unit according to claim 1, wherein the rotating device is a floppy disk drive.

5. A notebook computer's base unit according to claim 1, wherein the rotating device is a hard disk drive.
